(19) United States
(12) Patent Application Publication
(10) Pub. No.: US 2006/0274540 A1
(43) Pub. Date: Dec. 7, 2006

(54) Lighting system

(75) Inventors: Thomas D. Klaver, Ada, MI (US); Rodney J. Tindall, Zeeland, MI (US); Mark J. Bussis, Hudsonville, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/142,888

(22) Filed: Jun. 1, 2005

(51) Int. Cl. F21V 33/00

(52) U.S. Cl. 362/479

(57) ABSTRACT

A lighting system that may incorporate LEDs may include any number of features. For example, the lighting system may control dimming of LEDs to more closely match dimming of incandescent lights and/or may control the LEDs by translating the dimming signal received from the vehicle to a signal more appropriate for LEDs. The lighting system may store information relating to a characteristic (e.g. intensity, color, etc.) of the individual light sources and then control the light sources based on the saved information. The lighting system may include a flexible circuit carrying element having a heat dissipating (e.g. aluminum) backing. The lighting system may be configured to control the light sources (e.g. adjust intensity) based on ambient temperature information and/or based on ambient light information.

### BACKGROUND

The present application relates generally to the field of lighting, and many embodiments relate more particularly to vehicle lighting and lighting systems, and many relate more particularly to LED lamps and lighting systems incorporating LED lamps.

Use of LEDs has been proposed for use in automotive lighting. Examples include placing an LED lamp containing multiple LEDs in an automotive rearview mirror, as tail lights, as signal lights, or in other applications.

An inexpensive LED lamp with a number of features designed to improve quality of LED lamps is desirable.

### BRIEF DESCRIPTION OF THE DRAWINGS

FIG. 1 is a diagram of an exemplary lighting system according to some embodiments;

FIG. 1A is an exemplary processing circuit according to some embodiments;

FIG. 2 is a flow chart according to some embodiments;

FIG. 3 is a diagrammatic side view of a lamp according to some embodiments;

FIG. 4 is a diagrammatic top view of a lamp according to some embodiments; and

FIGS. 5-8 are exemplary circuit diagrams for lamps according to some embodiments.

### DETAILED DESCRIPTION OF EXEMPLARY EMBODIMENTS

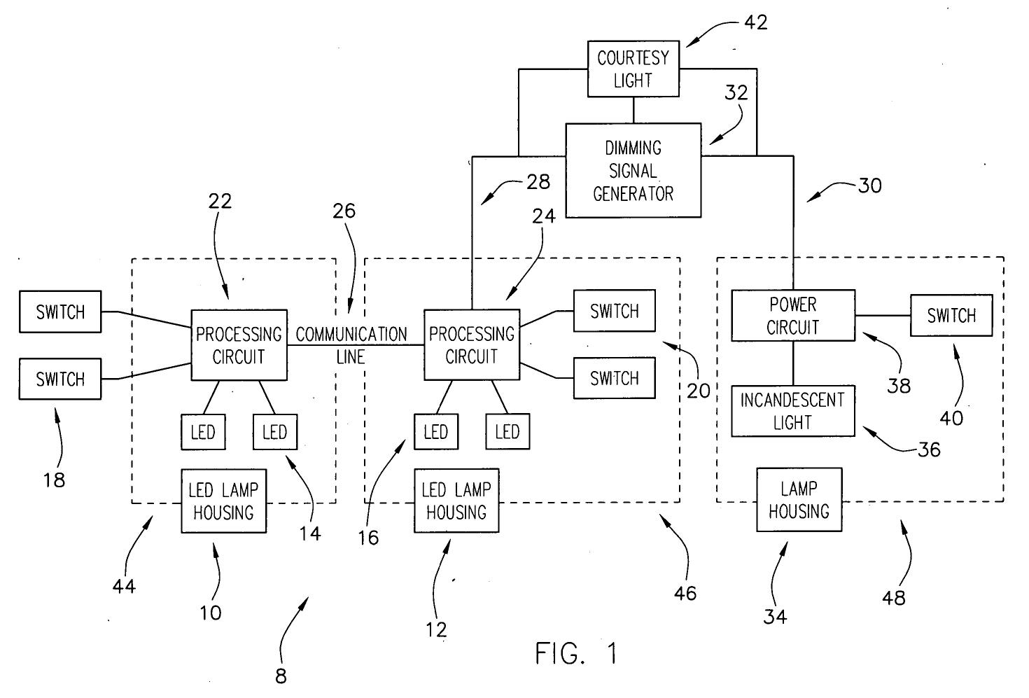

Referring to FIG. 1, a lighting system 8 for use in a vehicle includes a plurality of lamps 44-48. Lamps 44 and 46 include an LED light source and lamp 48 includes an incandescent light source.

In many cases, a vehicle provides a dimming input to a lamp to provide a “Courtesy” feature when the exterior doors are opened/closed, for instance, to slowly increase or decrease light intensity level.

A dimming signal generator 32 may send a dimming signal which may be received by a processing circuit 24 of a lamp 46. Processing circuit 24 may then identify the amount of dimming indicated by dimming signal generator 32 and translate it to provide a dimming signal appropriate for dimming one or more of LEDs 16.

Processing circuit 24 may translate the dimming signal received from dimming signal generator 32 by changing the frequency at which the dimming signal occurs. For example, processing circuit 24 may receive a dimming signal that is operating at 100 Hz and translate it to a signal at 500 Hz to control LEDs 16. According to some embodiments, processing circuit 24 translates the signal to operate at a frequency of no more than about 10,000 Hz or no more than about 5,000 Hz. According to some of these embodiments, processing circuit 24 translates the signal to operate at a frequency of no more than about 3,000 Hz or about 1,000 Hz. According to some embodiments (which may or may not include the above mentioned embodiments), processing circuit 24 may translate the signal to operate at at least about 100 Hz. According to some of these embodiments, processing circuit 24 may translate the signal to operate at at least about 200 Hz. According to some embodiments, processing circuit 24 may translate the received dimming signal to generate an LED dimming signal that operates at a higher frequency than the received dimming signal. In some embodiments, the frequency of the LED dimming signal is at least about twice as high as the received dimming signal. In some embodiments, the frequency of the LED dimming signal is at least about four times as great as the frequency of the received dimming signal.

Processing circuit 24 may also translate the received dimming signal by altering (e.g. increasing) the frequency of the signal and/or number of steps with which the light source is dimmed. Processing circuit 24 may also alter (e.g. decrease) the step size of each change in intensity. For example, the received dimming signal may go from an intensity of 90% to 80% to 70% with each step occurring over an interval of X seconds. Processing circuit 24 may translate the received signal to dim LEDs 16 from 90% to 88% to 86% with each step occurring over an interval of X/5 seconds. One method of controlling the changes in intensity is by adjusting the duty cycle of the signal used to control LEDs 16. While the curve (over time) of the dimming signal and the curve of the translated signal are shown as having a direct relationship in the example discussed above, in some embodiments the translated signal may not have a linear relationship to the received dimming signal. This may be particularly true at low intensities near the end of the dimming process where an LED may act differently than other light sources receiving the dimming signal. Further, one, both, or neither of the dimming signal and the translated signal may dim at a linear rate.

Processing circuit 24 may further translate the received dimming signal by changing the type of control method used to provide the translated dimming signal. For example, processing circuit 24 may translate a direct current voltage-based dimming signal received from dimming signal generator 32 to a pulse width modulated dimming signal to control LED 16.

By varying the duty cycle of the PWM output to the current control circuit, the light intensity may be increased or decreased. By controlling this feature with a microprocessor/microcontroller, the rate of dimming may be customized. This dimming rate may also be varied to match existing incandescent lighting in the vehicle if a mixture of light sources are used.

While translating a dimming signal has been discussed above, any other signal used to change the intensity of a light source (light intensity varying signal) may also be translated. For example, a signal used to increase the intensity of a light source may be translated (e.g. when a courtesy function is used to turn lights on, when a user remotely changes an intensity of the light source, etc.). Each reference to a dimming signal discussed above (or below) is equally applicable to other light intensity varying signals.

According to some embodiments, the LED lamp is connected to the same wiring and/or operates in response to the same control signals as an incandescent lamp. In this manner, this may allow a user to use LED lamps or incandescent lamps interchangeably, allowing a user greater flexibility to customize the lighting system of the vehicle.

Processing circuit 24 may include a microprocessor/microcontroller 50 that is configured to process the received light intensity varying signal and/or provide the translated light intensity varying signal. Microprocessor/microcontroller 50 may include a transfer function that inputs information based on a light intensity varying signal received from an external source such as the vehicle (e.g. dimming signal generator 32) and outputs a translated LED light intensity varying signal used in the control of LEDs 16.

Lighting system 8 may also include one or more incandescent lamps 48. The light intensity varying signal generated by the vehicle (e.g. dimming signal generator 32) may also be used to control incandescent lamp 48. The signal used to control incandescent lamp 48 may be the same signal as inputted by processing circuit 24. In other embodiments, the vehicle (e.g. dimming signal generator 32) may send different signals to incandescent lamp 48 and LED lamp 46.

LED lamp 46 and LED lamp 44 may be coupled such that information may be passed from one lamp to the other. For example, a dimming signal from dimming signal generator 32 may be inputted to lamp 46 and passed along to lamp 44 by way of lamp 46. In one type of coupling, lamps 44 and 46 may be networked such that information may be shared between lamps 44 and 46. For example, lamp 46 may translate the received dimming signal to an LED dimming signal. Lamp 46 may then send information relating to the translated LED dimming signal to lamp 44 rather than (or in addition to) sending the dimming signal received from dimming signal generator 32. In this way, processing circuit 22 may control LEDs 14 based on the translation done by processing circuit 24. Other information such as temperature information, ambient light information, and any number of other types of information may be shared between lamps 44 and 46.

In some embodiments, processing circuit 24 may control LEDs 16 based on an amount of ambient lighting. In some embodiments, processing circuit 24 may be configured to control LEDs 16 based on the amount of ambient lighting for purposes of a courtesy function. For example, circuit 24 may control LEDs 16 to not turn on during the courtesy function if there is at least a predetermined amount of ambient light, and to turn on the LEDs during the courtesy function if there is not at least a predetermined amount of ambient light. Processing circuit 24 may alternatively use any other predetermined criteria or algorithm based on an amount of ambient light to control LEDs 16. Also, processing circuit 24 may control the LEDs in any manner in addition to or as an alternative to controlling the LEDs to be on or off (such as using dimmer light during times of high ambient light, and/or by placing the LEDs into more than two states of operation).

As some examples of a courtesy function, a courtesy function may be activated when a command is triggered on a remote keyless entry device (such as an unlock command), when a door of the vehicle is opened, when ignition is turned off and/or when a key is removed from the ignition, etc. The general purpose of a courtesy lighting function is to provide lighting at a time when it is likely that a user would desire or require lighting without requiring the user to specifically (directly) activate the lights.

Preventing the LEDs from not being activated during daytime may allow the lifetime of the LEDs to be extended and potentially decrease the amount of replacement needed for the LEDs.

According to some embodiments, ambient light levels can be used to control intensity to reduce light interference on the driver from the light source in low light (night or morning) when driving. For example, processing circuit 24 may input information relating to the ambient light level to determine maximum operating intensities for LEDs 16 and/or LED lamp 46.

According to some embodiments, ambient light levels may be used to control an amount of light provided by a vanity lamp. Light provided by an LED-based vanity lamp may be increased as ambient light levels decrease.

Other lamps, including lamps 44 and 48, may also be controlled based on the amount of ambient light, such as being controlled during a courtesy lighting function, during low light, and/or in vanity applications in a manner similar to that discussed above for lamp 46.

Ambient light may be measured by a photo sensor (not shown) or any other sensor or device that provides data relating to an amount of ambient light. The sensor may be located in a lamp housing 10, 12, 34 or may be located remote from a lamp housing. Ambient light measurements used by processing circuit 24 may be received from one or more sensors, which may be placed in one or more locations.

Processing circuit 24 may also be configured to control LEDs 16 based on the ambient temperature. For example, as ambient temperature increases, processing circuit 24 may be configured to reduce the intensity of (e.g. by reducing an amount of current supplied to) LEDs 16.

In one exemplary embodiment, when a pre-determined ambient temperature is achieved, the duty cycle of the PWM output to the current control circuit may be reduced, reducing the amount of time the drive circuit and LED(s) are kept on. The light output intensity may be decreased, while the junction temperature of the components may be held within predetermined limits.

The ambient temperature used to control LEDs 16 may be monitored by any number of means. As some examples, processing circuit 24 may include a dedicated temperature sensor (e.g. a thermistor), or may use circuits having a function other than sensing temperature which may also provide information relating to the ambient temperature. With respect to circuits having functions in addition to providing information relating to ambient temperature, some circuits may have properties that change with respect to temperature. These properties can be monitored to obtain information relating to the ambient temperature. For example, a microprocessor/microcontroller might have a timing function whose timing interval changes based on changes in temperature (e.g. the interval may increase when temperature increases). The length of the interval of the timing function may be monitored to obtain information relating to the ambient temperature. In one example, the timing function may be used to reset the firmware running on the microprocessor/microcontroller should the firmware get stuck in a portion of the program.

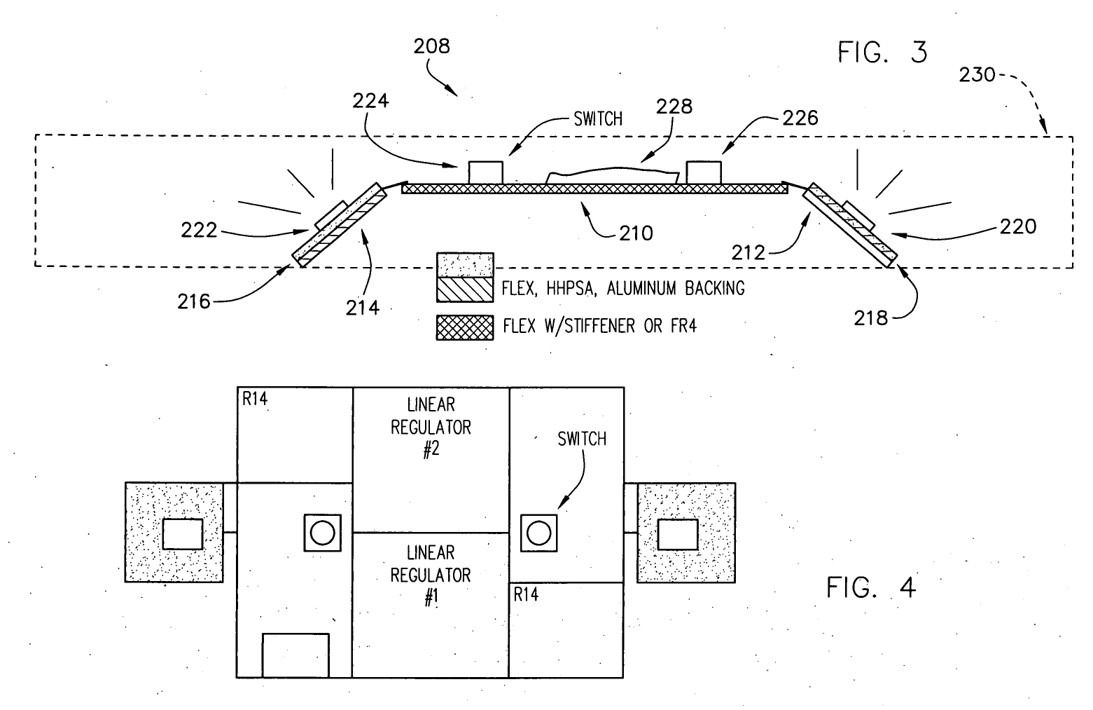

In some embodiments, the ambient temperature that is monitored may be the ambient temperature in proximity to LEDs 16. In other embodiments, the ambient temperature that is monitored may be an ambient temperature that is not in close proximity to LEDs 16. In other embodiments, ambient temperature may be monitored both in proximity to LEDs 16 and also not in proximity/close proximity to LEDs 16. As one example of monitoring ambient temperature using a sensor that is not in proximity to LEDs 16, the ambient temperature may be monitored in proximity to LEDs 14, and used to control LEDs 16. As another example, ambient temperature may be monitored by monitoring a feature of a processing circuit 228 (FIG. 3), which processing circuit 228 is not in close proximity to LEDs 220, 222 (FIG. 3). One such feature may be the timing of microprocessor/microcontroller 50 mentioned above.

Lamps 44, 46 may also include one or more switches 18, 20 which can be used to control any number of features of lamps 44, 46 and/or other accessories (e.g. a compass, an electrochromic mirror, a garage door opener, etc.) coupled to lamps 44, 46. One potential type of switch that may be used is an ON/OFF switch used to control supply of power to the light sources of the lamps. Switches 18, 20 may be located within housings 10, 12 or outside of housings 10, 12.

ON/OFF switch inputs 18, 20 may be located remotely from the individual lighting modules. This feature could allow control of the rear vehicle lighting from the driver or front passenger positions, for instance, without lighting the front of the vehicle (not interfering with the driver's vision).

Switches 18, 20 may also be used to control the intensity of each LED 16. The intensity of each LED 16 and/or lamp may be individually controlled, and may be configured to be controlled by a user using switches 18, 20. For example, each user may individually control dimming level by actuating switch 18, 20 (e.g. an ON/OFF switch) for the appropriate LED. Along with providing ON/OFF control, if the light is switched ON and switch 18, 20 is not immediately released, the continued input to processing circuit 22, 24 may initiate a repeated slow dim and/or slow on feature. Dimming level can then be set by releasing switch 18, 20 at the desired light level. A memory feature may be available to retain this setting each time the LED 16 and/or LED lamp 46 is activated. In some embodiments, this memory may be used in conjunction with a remote keyless entry or other device to remember settings for more than one user depending on the remote keyless entry or other device actuated.

Referring to FIG. 1A, processing circuit 24 may include a microprocessor (microcontroller) and additional circuitry 54. Additional circuitry 54 may include a driver circuit portion (which may include a constant current portion), and an incoming power filtration circuit portion (e.g. ESD, transient, and reverse voltage filtration).

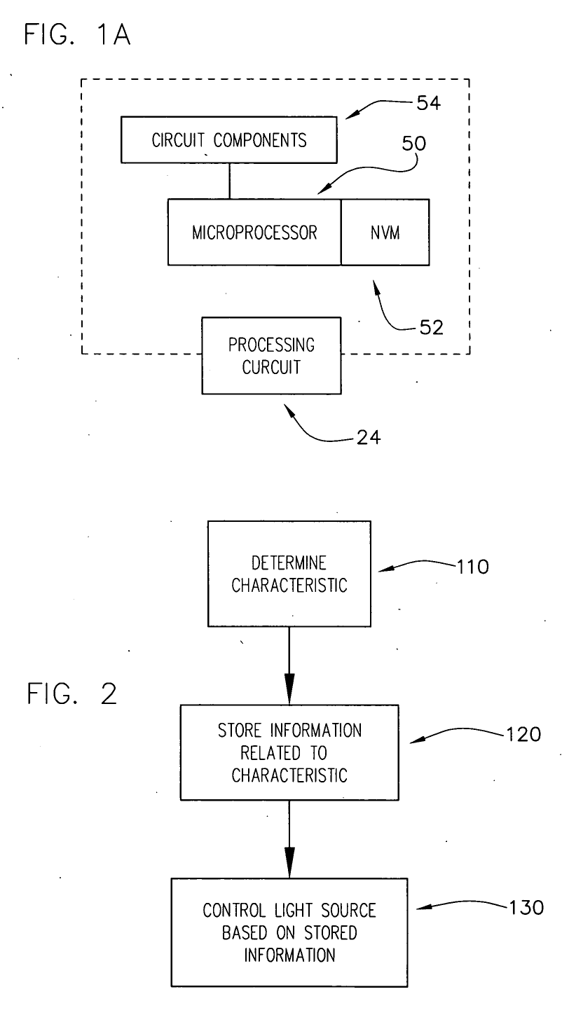

Referring to FIG. 2, a method of controlling a light source, such as an LED 16, includes determining a characteristic of the light source at block 110, electronically storing information relating to the characteristic at block 120, and controlling the LED lamp based on the information at block 130.

The characteristic of the light source may be determined at block 110 in any number of ways. For example, the characteristic may be measured for each light source. Measuring may occur during the process of manufacturing the lamp 46 containing the light source 16, and may occur when the light source 16 is installed in the lamp 46.

In some embodiments, the manufacturer of the light source may measure the characteristic and determining the characteristic might include utilizing the information provided by the manufacturer of the light source.

Measuring may also occur during operation of the lamp. For example, a forward voltage across an LED circuit may be measured during operation of the lamp. This may be done by any number of means including using an A/D converter to convert the value of the forward voltage to a value readable by a microprocessor/microcontroller or other digital processing circuit. As another example, a light intensity sensor may be located in the lamp 46 or the vehicle such that the intensity of light from the light source 16 and/or lamp 46 can be determined.

When determining the characteristic, the exact value of the characteristic of the light source may be determined, or the value of the characteristic may be assigned within a range of values (e.g. 30-32 lux of intensity, etc.).

The measured characteristic may include any number of types of information. Some examples of information that may be useful include the relative intensity of the light source, the color output by the light source, and/or the forward voltage of the light source.

For LEDs, an LED manufacturer may provide information such as a bin # where each bin represents a range of intensities, a range of colors, or a range of colors in combination with a range of intensities. The bin # for the LEDs to be included in a particular lamp may be used to determine values for one or more of the characteristic(s) of the LEDs represented by the bin #.

Electronically storing the information relating to the characteristic at block 120 may involve one or more of any number of electronic devices. For example, the information relating to the characteristic for the light source may be written to a memory (preferably a non-volatile memory) associated with a processing circuit 24 (FIG. 1) such as a processing circuit 24 including a microprocessor/microcontroller 50 (FIG. 1A). In another embodiment, a value of a resistor or other circuit component may be used to represent the value of the characteristic, which resistor value or other component value can be determined by processing circuit 24. In another embodiment, a circuit component may be placed in series or in parallel with the light source, the value of the characteristic of the light source being used to determine the value of circuit component. In another embodiment, the value may be stored by a mechanical switch (e.g. dip switch) whose position is readable by a processing circuit. In another embodiment, a plurality of conductive traces may exist and one or more conductive traces may be cut to signify the value of the characteristic.

The information stored at block 120 can be used to control the operation of the light source and/or the lamp of which the light source is a part. In some embodiments, the light source may be controlled by changing the amount of current provided to the light source. In some embodiments, the light source may be controlled by controlling a switch (such as a solid state switch) which switches through different paths where each path offers a different amount of resistance. Control may be exercised by microprocessor/microcontroller 50 or by any other control/processing circuit.

In one exemplary drive system, the LED forward voltage variation may be compensated by using a current control on the low side of the LED string. By fixing the amount of current running through each string of the LED(s), the differences in the forward voltage of each individual LED may be set such that it does not affect the intensity of the light output. In a purely resistive drive circuit, the voltage drop over the LED along with resistance in the circuit tend to determine the current driven through the LED. By controlling this drive current independently of the forward voltage drop, each string should receive the same amount of current. In one exemplary embodiment, current control may be attained through the use of a National Semiconductor LM317 linear regulator, comparator/FET, and/or BJT transistor circuit and reference resistor.

By having information relating to the characteristic stored, uniformity may be increased between separate lamps even where light sources are selected that have widely varying values for the characteristic. For example, knowing the intensity of an LED may allow a processing circuit 24 to control the intensity of a lamp 46 such that multiple lamps (44, 46, etc.) can be configured to have about a same level of intensity even though the particular LEDs used in the lamps have differing intensities at the same current level. A processing circuit 24 may control an amount of current provided to each LED (or string of LEDs) 16 such that each LED (or string) provides a similar amount of light output.

As another example, a processing circuit may use information relating to a color output by an LED to control multiple lamps to output a same color. For example, white LEDs are generally formed by outputting light of a single color from an LED chip (e.g. blue light) and then including one or more types of phosphors in the resin which encapsulates the LED chip, which phosphors absorb some of the light of the single color emitted by the chip and convert the light to a different color or different colors. The combination of the colors emitted by the chip and the phosphors then appear a different color (e.g. white) to an observer. If such an LED were provided a greater current, then the chip may provide additional light, which additional light might be more than can be handled by the phosphors, which may result in a blended color of light which has a color closer to that of the light emitted by the chip (i.e. the phosphors would absorb and convert a smaller percentage of the increased intensity of light). The opposite may also be true; emitting less light from the chip allowing the phosphors to absorb and convert a greater percentage. Thus, information relating to a color of an LED may be used to control the LED in such a way as to give a more consistent color from one LED or LED lamp to another LED or LED lamp, which control may take the form of adjusting an amount of current provided to the LED. If more than one LED of different colors are used, control of the color may be achieved by adjusting the relative intensities of the various colors of LEDs.

Values for more than one characteristic of the light source may be determined, stored, and/or used to control the function of the light source or lamp in which the light source is installed.

In addition to controlling a first light source based on its characteristic, processing circuit 24 may control other light sources based on the characteristic of the first light source. For example, a first light source may be in a string of light sources and processing circuit 24 may control the entire string of light sources based, at least in part, on the value of the characteristic of the first light source. As another example, where multiple LEDs of different colors are used in a lamp, the intensity used to drive one color of LED may be based on the relative intensity of an LED of another color.

Also, a value of a second light source may be used in combination with the value of the first light source to control one or both of the first and second light sources.

The light sources may be LEDs, but may also be any other type of light source, such as any other type of solid state or diode-based light source.

Referring to FIG. 3, an LED lamp 208 includes a circuit carrying element 210. Circuit carrying element 210 may be a flexible circuit carrying element, may be a rigid circuit carrying element (e.g. a circuit board, a stiffened flex circuit, etc.), a stamped circuit, or some other type of circuit carrying element. Circuit carrying element 210 may be configured to carry various circuit elements such as some or all of the components of a processing circuit 228 and/or switches 224, 226.

LED lamp 208 may also include flexible wings/extensions 212, 214 coupled (e.g. directly connected) to circuit carrying element 210. Flexible extensions 212, 214 may be circuit carrying elements or may connect circuit carrying elements. Flexible extensions 212, 214 may be made from the same material as or a different material than circuit carrying element 210. Flexible extensions 212, 214 may be configured to carry light sources 220, 222 such as LEDs. Extensions 212, 214 may be connected to circuit carrying element 210 by other means such as by wires.

A heat dissipating material 216, 218 such as aluminum may be used as a backing in areas of heat generation, such as around light sources 220, 222, driver circuitry, etc (e.g. portions of processing circuit 228). In some embodiments, heat dissipation material 216, 218 is only used in areas of relatively higher heat generation, and in some embodiments only in areas around light sources 220, 222. Heat dissipation materials 216, 218 may be flexible or may be rigid.

In some embodiments, heat dissipation materials 216, 218 may be fixed to the circuit carrying element. For example, an aluminum backing may be fixed to a flexible circuit carrying element such as a flex circuit.

In one embodiment, circuit carrying element 210 is a rigid circuit carrying element while flexible wings 212, 214 are flexible circuit carrying elements with an aluminum backing in an area around light sources 220, 222 which light sources include LEDs.

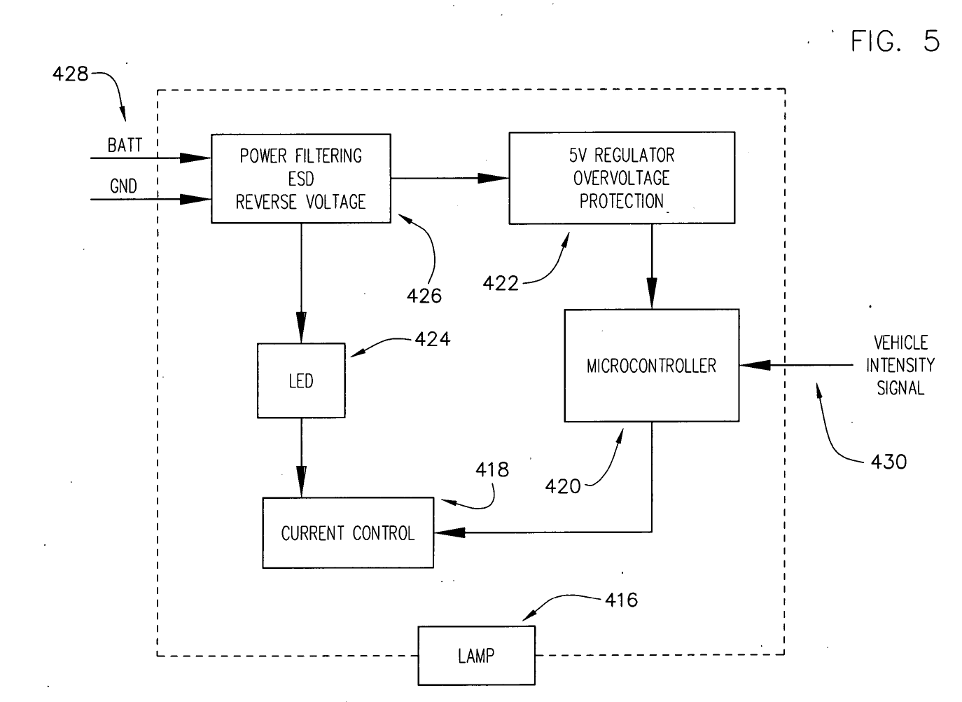

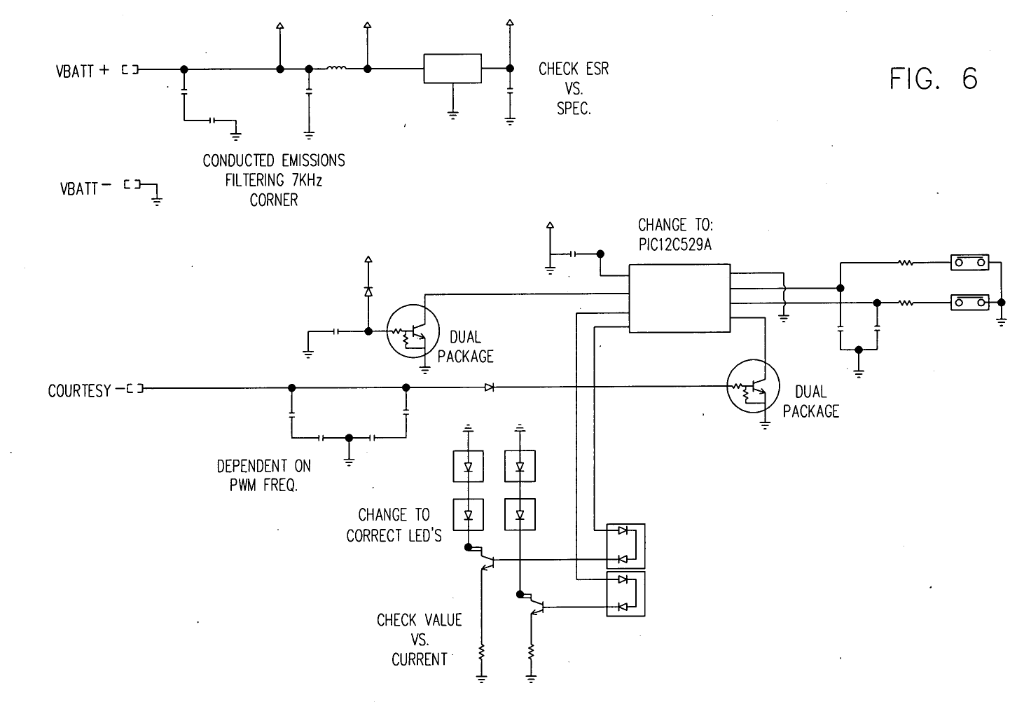

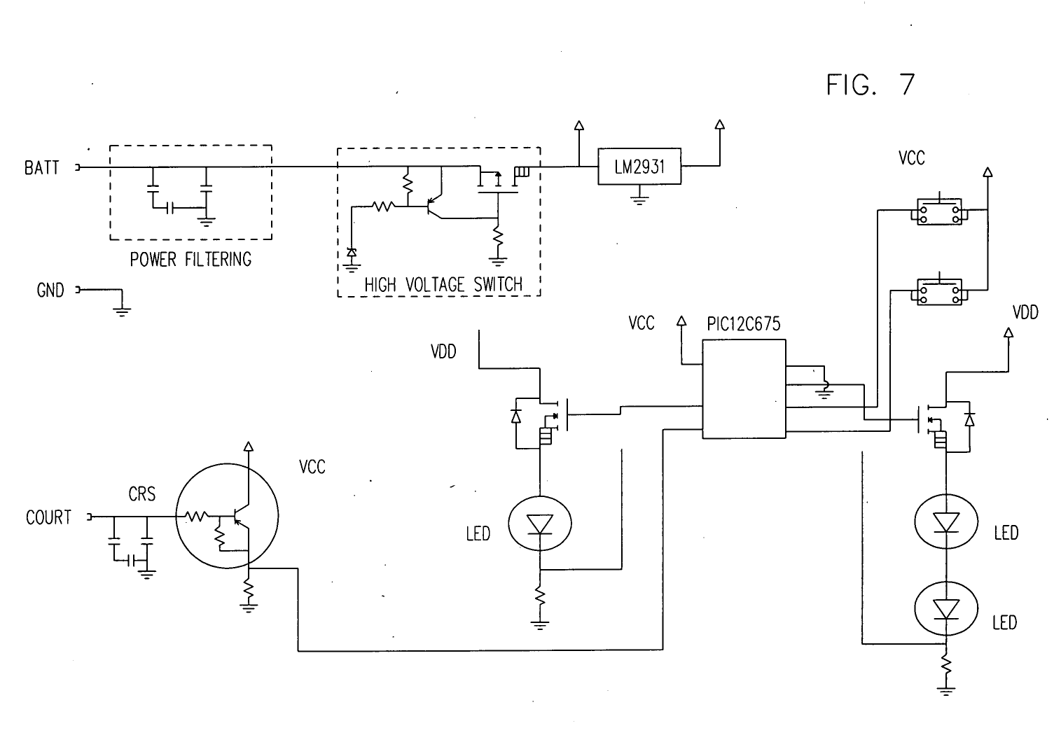

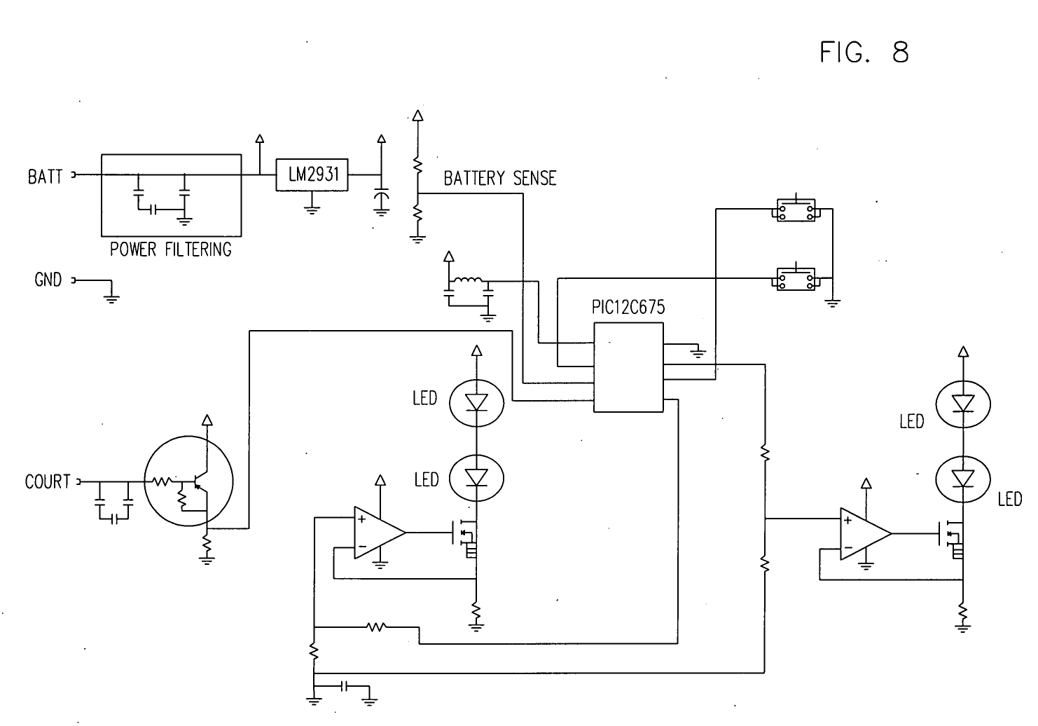

Referring to FIG. 5, lamp 416 includes an LED 424. LED 424 receives power from power source (battery) 428 after the power has been filtered and/or processed by power filtering circuit 426. Power filtering circuit 426 may be used to protect against ESD and/or reverse voltages. Microcontroller 420 receives a light intensity signal 430 from an external source and, based on signal 430) outputs a signal to control a current control section 418 which controls intensity of LED 424.

Referring again to FIG. 1, LED lamp 46 may include a housing 12 to contain the components of LED lamp 46. The housing may contain all or a portion of processing circuit 24, one or more user interfaces such as switches 20, and/or LEDs 16. Housing 12 may be a single component housing or may include multiple components. In some embodiments, LEDs 16 may be included in swiveling (or other moving) portions while other portions of housing 12 remain still. In some embodiments, all of the components of housing 12 may be configured to be in a moving portion.

While lamps 44-48 are show as being located in separate housings, two or more of lamps 44-48 may be contained in a single housing and/or may share some common circuit components. Housings 10, 12, and 34 may be formed from plastic or may be formed from some other material.

Housing 12 may include vents which vents may allow heat to be vented out of the housing. Housing 12 may also contain connectors which allow the housing to be mounted to a vehicle such as an automobile. Housing 12 may be mounted to or formed in an interior component of the vehicle such as a headliner, a console, a glove compartment, a rearview mirror, a vanity mirror, or other interior component. Housing 12 may also be mounted to or formed in a footwell area, a door, or other portion which may allow light to be provided exterior of the vehicle.

LEDs 14, 16 may be white LEDs or may be other color LEDs. The light from a single LED-based lamp 44, 46 may be configured to provide substantially white light, may be configured to provide a tinted white light, or may be configured to provide a color other than a white color (e.g. a shade of blue, or yellow, or orange, etc.). White light and shades of white light may be emitted by using a white light emitting LED or may be emitted by using a combination of colored LEDs (e.g. red, green and blue or blue and yellow) or may be emitted using a colored LED in combination with a color conversion system (e.g. a lens containing phosphors). A single lamp may include a single LED or may include multiple LEDs.

While FIG. 1 shows two lamps 44, 46 each having two LEDs, an LED containing lamp according to a claim below may have one LED, or any number of LEDs more than one, unless specified otherwise. Some exemplary interior LED lamps may include 1 to 5 LEDs, and some of these embodiments may include 1-3 LEDs.

Reference to an LED may be used to reference any type of LED such as a standard inorganic solid-state LED, an organic LED, a polymer LED, and so on, unless stated otherwise. Many exemplary embodiments would include inorganic LEDs.

While much of the discussion is directed to LEDs, much of the disclosure is applicable to other solid state light source based lamps and/or to other light sources generally. The claims are not limited to LED light sources unless specified as limited to LED light sources in the claims.

Any lamp that includes an LED light source may also include other types of light sources as well. For example, a single lamp may include both an LED and an incandescent light.

LEDs may be purchased from any number of manufacturers including Osram, Nichia, Agilent, Lumileds, Toshiba, and other manufacturers. Circuits and/or other components for use in controlling LEDs can likewise be purchased from a number of manufacturers. For example, components may be purchased from National Semiconductor, AMI, Maxim, and/or Microchip. A heat dissipation material such as aluminum may be fixed to a flexible circuit by any number of methods including methods used by Sheldahl Circuits.

Other Properties of Lamps

Some exemplary locations in which LED dome/courtesy lamp may be incorporated include the headliner, overhead console (including outer surface of bin door), trim (e.g. perimeter trim), overhead HVAC vent, visor, overhead rail modules, along or inside of overhead rails, in assist handle & bezel, pillar trim, on sunroof or glass (panoramic) roof, sunroof shade, and other locations. Some exemplary locations in which LED map/reading lamps may be incorporated include the headliner, overhead console, interior trim around the openings in the vehicle body, overhead HVAC vent, visor, overhead rail modules, on sunroof or glass (panoramic) roof, sunroof shade, and others. Exemplary locations in which LED ambient, orientation, conversation, and utility lamps may be incorporated include the headliner, overhead console, integrated with task or courtesy lamps, in visor, trim system, overhead HVAC vent, overhead rail modules, along or inside of overhead rails, in assist handle & bezel, coat hook, on sunroof or glass (panoramic) roof, sunroof shade, pillar trim, sidewall trim, carpeting (along rocker or below 2^{nd}/3^{rd} row cushion), along or inside of floor rails, seat back (front side (office lamp) and rear side (rear seat utility lamp)), seat frame (for floor), seat cushion, seat highlights, head restraint, arm rest, seat belt, seat belt buckle, front or underside of IP, around HVAC vents on IP or floor console, on-sides or back of floor console, on door panel, door handle, door pull cup or strap, sill plate, and others. Exemplary locations for LED trunk lamps include the underside of shelf, in sidewall trim/carpet, on underside of deck lid, and others. Exemplary locations for LED cargo lamps include the headliner,trim system, glass (panoramic) roof, sidewall trim, seatback, seat frame, lift gate, and others.

LED visor vanity lamps may be configured to be located along any or all sides of the vanity mirror, on the mirror cover, and/or on the headliner or the trim above visor. Further, a vanity lamp could also be designed to shine through the mirror. LED glove box lamps may be configured to be located on the top surface or sides of the box or may shine through the top or sides of the box. LED ash receiver lamps may be configured to illuminate the ash receiver. Additionally, these lamps could be used to put a ring around all or part of the receiver. LED cup holder lamps may be configured to be located along the bottom or sides of the cup holder, around the top of the cup holder, or on an adjacent part (for example, the floor console, IP, or sidewall trim) to illuminate the cup holder. LED storage bin lamps may be configured to be located on the sides or cover of the bin, shine through the sides or cover of the bin, or may be located above the bin. LED footwell lamps may be configured to be located on the underside of the IP, on the hush panel, on the pillar trim, on the sidewall trim, on the seat frames, on the seat cushion, on the carpeting (such as along the rocker or below the 2^{nd}/3^{rd} row cushion), on the sides or back of the floor console, on the sides or front or back of the floor rail module, and other locations. LED door lamps may be configured to be located on the lower door panel (such as a puddle/step lamp; door open lamp, with or without reflector), on the map pocket, on the upper door panel (task/utility light), on the rearward edge (e.g. to highlight for aid in ingress/egress), and other locations. LED lamps may be used to illuminate or backlight decorative features. These decorative features may include features used to identify brands. Further, these lamps could provide bars of light and may define the outline of an object or area such as the passenger or driver seat area. LED lamps may also be used to illuminate various other components. These lamps may be configured to illuminate the steering wheel rim, the spokes, the hub, and various other components of a vehicle.

According to many embodiments, an LED lamp is an interior LED lamp configured to provide illumination to an interior portion of the vehicle. In many of these embodiments, the LED lamp is configured to provide sufficient light to allow a user to read. According to some embodiments, the LED lamp may provide at least 5 or 10 lux intensity at 20 inches and/or at a target area of the vehicle. According to some of these embodiments, the interior lamp may provide at least about 25, at least about 40 or at least about 60 lux at 20 inches and/or at a target area of the vehicle.

In some cases the luminous intensity of one light-emitting diode 16 alone is not sufficient for illuminating a sufficiently large field of illumination with adequate luminous intensity. In these cases several light-emitting diodes 16 may be combined in the lighting device, in order to add the luminous intensities of the individual light emitting diodes 16 on the field of illumination.

One or more secondary optical elements may be used with the above described LED lamps. Secondary optical elements are components that influence by combination of refraction, reflection, scattering, interference, absorption and diffraction the projected beam shape or pattern, intensity distribution, spectral distribution, orientation, divergence and other properties of the light generated by the LEDs. Secondary optical elements may include one or more of a lens, a deviator, and a diffuser, each of which may be in conventional form or otherwise in the form of Fresnel (e.g. a micro-groove Fresnel) equivalent, a HOE, binary optic or TIR equivalent, and/or another form.

A deviator may be optionally mounted on or attached to the housing or otherwise attached to or made integral with a surface of a lens and may be used to steer the collimated beam in a direction oblique to the optic axis of the lens and/or reflector used in the LED/emissive lamp 100. The deviator may be a molded clear polycarbonate or acrylic prism operating in refractive mode or in TIR mode (such as a periscope prism). This prism may further be designed and manufactured in a microgrooved form such as a Fresnel equivalent or a TIR equivalent. Furthermore, a diffraction grating, binary optic or holographic optical element can be substituted for this prism to serve as a deviator. The deviator may be configured as a sheet or slab and may substantially cover the entire opening of the housing of the lamp from which light is emitted.

Optionally, a diffuser (e.g. integrated as part of a cover) may be mounted on or coupled to housing 12 or may be attached to or made integral with a surface of the lens or with a surface of a deviator. The diffuser may be used to aesthetically hide and/or physically protect the internal components of the lamp, and/or to filter the spectral composition of the resultant light, and/or narrow, broaden or smooth the light's intensity distribution. The diffuser may incorporate a unique spectral filter (such as a tinted compound or an optical coating such as dichroic or band pass filter) to enhance aesthetics, hide internal components from external view, and/or correct the color of mixed light projected by the lamp. The diffuser may be a compression or injection molded clear polycarbonate or acrylic sheet whose embossed surface or internal structure or composition modifies impinging light by refraction, reflection, total internal reflection, scattering, diffraction, absorption or interference.

In some embodiments at least two optical components may be combined into one integral piece. For example, a deviator can be incorporated onto an upper surface of a lens by placing an appropriately machined mold insert into the planar half of a mold for a Fresnel or TIR collimator lens. As mentioned above, a diffuser may also be attached to or made integral with the lens surface or the deviator surface. The individual light-emitting diodes 16 of the LED lamp 46 may be combined on a printed circuit board, flex circuit, and/or conductor foil (pcb's) so as to form an LED module. Via the printed circuit board or conductor foil the light-emitting diodes 16 can be provided with current centrally and the LED module can be mounted in the form of a prefabricated subassembly in a housing 12. As a matter of principle, the electronics for driving the light-emitting diodes 16 may be arranged at any place in the vehicle, even at a place remote from the light-emitting diodes 16, for instance by integration into an on-board computer. In some embodiments, the electrical circuits 24 for driving the light-emitting diodes are combined together with the light emitting diodes 16 on a printed circuit board or conductor foil so as to form an LED module.

If the LED lamp 16 is employed in the exterior region of the motor vehicle or in a potentially wet region of a vehicle interior (e.g. in a door, a floor carpet, a cup holder, etc.), measures may be taken in order to rule out contact of the LED module with water. The moisture protection can be achieved by coating the LED module at least zonally with a water resistant material, for instance by dipping in or applying a water resistant material (e.g. a resin). The light emitting diode 16 or the LED module may be permanently coupled to the housing 12. This may be accomplished, for instance, by bonding the components with adhesive.

The lenses may be smooth lenses—that is, lenses having a smooth lens surface. Lenses with surface structure (e.g. Fresnel lenses) are also usable (although the surface structure may tend to reduce the light efficiency of the lighting device).

The protective cover and the housing may be manufactured jointly in a multi-part injection-molding process. The housing and the cover may be manufactured simultaneously in a common injection mold. In the process, the cover connects to the housing at an interface, so that the cover may become an integral constituent of the housing. Alternatively, the two components may be manufactured separately and are connected by a clip connection or other type of connection. Since fluctuations in the operating voltage in the on-board supply system of a motor vehicle may occur which can damage the light-emitting diodes, measures may be taken to protect the light-emitting diodes and/or circuit components (e.g. control circuit) against overvoltages and/or reverse voltages. For example, at least one protective diode (e.g. as part of processing circuit 24) may be connected in series or parallel to the light-emitting diodes in order to protect them against polarity reversal.

An LED lamp may be configured as an individual subassembly—ie, with its own housing—and to secure it in or on the vehicle. Instead, an LED lamp may be configured as a subassembly to be combined in part of an assembly such as an overhead console, a rear view mirror, or some other assembly. LED lamp 46 could be integrated into many assemblies of a motor vehicle. Exemplary assemblies include bumpers, sunroof operating modules, luggage-compartment covers, engine-compartment covers, glove compartments, ashtrays, storage compartments, center consoles, seats, and other subassemblies.

### EXEMPLARY CIRCUIT

An exemplary circuit and lamp is illustrated in FIGS. 3-5.

| Ref | | | | | | |
|---|---|---|---|---|---|---|
| Des | Part Name | DESCRIPTION | VALUE | TOL | POWR | VOLT |
| U1 | P_PIC12C671-T01136 | IC 8-BIT CMOS | | | | |
| | | MICROCHIP | | | | |
| | | PIC12C671 | | | | |
| CR5 | P_914_SOT23-V30082 | DIODE SIG | | | | |
| | | 75 mA 100 V | | | | |
| | | 1N914 | | | | |
| Q2, | P_BCP54_SOT223-V46663 | TRANS NPN | | | | |
| Q3 | | BCP-54 | | | | |
| CR8, | P_BAV99_SOT23-V56967 | DIODE DUAL | | | | |
| CR9 | | SERIES BAV99 | | | | |
| CR1 | P_4004_SQR-V80470 | DIODE REC | | | | |
| | | SQUARE 1A | | | | |
| | | 400 V 1N4004 | | | | |
| R9 | P_RES_2010-V86292 | RES CER | 100 | 5% | 0.5 | |
| J1 | P_CON_3_3-V90893 | CONN HDR 3 | | | | |
| | | PIN .100 CTR | | | | |
| S1-S3 | P_SWITCH_2PIN-V99300 | SWITCH MOM | | | | |
| | | SMD RUBBER | | | | |
| | | CONT 120 gf | | | | |
| U2 | P_LM2931_DPAK-VA1565 | IC REG 5 V | | | | |
| | | LM2931 | | | | |
| Q4 | P_MUN2111T1-VA6372 | TRANS PNP DIG | | | | |
| | | 10 KB/10 KBE | | | | |
| C10, | P_CAP_603-VB7587 | CAP CER X7R | .1U | 10% | | 16 |
| C12, | | | | | | |
| C13 | | | | | | |
| R7, | P_RES_5_063-VB8384 | RES CER | 100 | 5% | 0.063 | |
| R8 | | | | | | |
| L2 | P_IND-VB8612 | INDUCTOR SMD | 680N | 10% | | |
| R3 | P_RES_5_063-VC2865 | RES CER | 470K | 5% | 0.063 | |
| R1, | P_RES_2512-VE3147 | RES CER | 20 | 5% | 1 | |
| R2 | | | | | | |
| C9 | P_CAP_NIOBIUM-VS3494 | CAP NIOB D- | 100U | 20% | | 6.3 |
| | | CASE | | | | |
| L1 | P_IND-VT7559 | INDUCTOR SMD | 47U | 10% | | |
| C1-C3, | P_CAP_603-VV5381 | CAP CER X7R | .022U | 10% | | 50 |
| C5, | | | | | | |
| C7, | | | | | | |
| C8 | | | | | | |
| CR3, | P_LED-VV7751 | LED SMD | | | | |
| CR4, | | (WHITE) | | | | |
| CR6, | | | | | | |
| CR7 | | | | | | |

### Illustrative Embodiments

One embodiment is directed to a method for operating an interior LED lamp in a vehicle may include receiving a signal used to vary an intensity of a light source (e.g. a dimming signal) and translating the signal for use in altering the intensity of (e.g. dimming) an LED.

The LED may be configured to illuminate an interior of a vehicle. The signal may be configured to alter an intensity of an incandescent light source. Translating may comprise altering the LED in smaller increments (steps) than the received signal. Translating may comprise using a higher frequency to control the LED than received from the signal. A frequency used to control the LED may be at least about 200 Hz. Translating the signal may comprise translating the signal using a microprocessor/microcontroller. The microprocessor/microcontroller and the LED may be located in a common housing. The method may further comprise translating the signal with a microprocessor/microcontroller for use in changing the intensity of a second LED not in a common housing as the microprocessor/microcontroller. The LED may be a white LED.

Another embodiment is directed to an interior lamp for a vehicle comprising an LED light source configured to illuminate the interior of a vehicle, and a processing circuit configured to receive a signal used to change the intensity of a light source and to translate the signal for use in changing the intensity of the LED light source.

The processing circuit may comprise a microprocessor/microcontroller. The lamp may further comprise a housing configured to contain each of the components of the processing circuit.

Another embodiment is directed to a method for operating an interior LED lamp in a vehicle comprising dimming an incandescent lamp based on a dimming signal, and dimming the interior LED lamp based on the dimming signal.

The incandescent lamp and LED lamp may be controlled such that they appear to dim at a similar rate to a user.

Another embodiment is directed to a method for operating an interior LED lamp in a vehicle comprising determining that the intensity of the interior LED lamp should be changed/varied, sending a light intensity varying signal, and varying the LED lamp in increments undetectable to a person in the interior of the vehicle.

Varying the intensity of the LED may comprise dimming the LED to less than about 10% of its maximum output or less than 5% of its maximum output.

Another embodiment is directed to a method for operating an interior LED lamp in a vehicle comprising determining a characteristic of an LED of the interior LED lamp, storing information relating to the characteristic in an electronic form, and controlling the LED based on the stored information.

The characteristic may relate to an intensity of the LED. The characteristic may relate to a color of the LED. The method may further comprise determining a characteristic of a second LED of the interior LED lamp, storing information relating to the characteristic of the second LED in an electronic form, and controlling the second LED based on the stored information. The method may also further comprise controlling the first LED based on the stored information relating to the characteristic of the second LED.

Another embodiment is directed to an interior lamp for a vehicle comprising an LED light source configured to illuminate the interior of a vehicle, and a processing circuit configured to receive information relating to a characteristic of an LED of the LED light source, and to control the LED light source based on the information.

The processing circuit may be configured to control the LED light source based on the information by adjusting the intensity of the light source. The processing circuit may be configured to control the LED light source by adjusting an amount of current provided to at least one LED of the LED light source. The LED light source may comprise at least two LEDs. The processing circuit may be configured to control the LED light source by compensating for forward voltage provided in a circuit comprising at least one LED of the LED light source. The processing circuit may be configured to control the LED light source by switching an amount of resistance that is provided in series with at least one LED of the LED light source.

Another embodiment is directed to an interior lamp for a vehicle comprising an LED configured to illuminate the interior of a vehicle, a rigid circuit carrying element that carries components of a circuit of the interior lamp, the components coupled to the LED, and a flexible circuit carrying element coupled to the rigid circuit carrying element, the LED being connected to the flexible circuit carrying element.

The flexible circuit carrying element may comprise a heat dissipating backing in the area of the LED. The heat dissipating backing may be rigid. The heat dissipating backing may comprise or consist essentially of one or more of aluminum, copper, steel, thermally conductive resin, and/or other heat dissipating materials. In some embodiments, the material may consist essentially of one of the above mentioned materials (e.g. aluminum or copper).

Another embodiment is directed to an interior lamp for a vehicle comprising a light source, circuit components electrically coupled to the light source, and a heat dissipating backing around the light source. In this embodiment, the heat dissipating backing is only located around the light source and/or drive circuit.

Another embodiment is directed to an interior lamp for a vehicle comprising a light source, circuit components electrically coupled to the light source, and a heat dissipating material around the light source. A relative position between the circuit components and the light source is flexible.

The circuit components may comprise at least a switch and a resistor. The circuit components may be mounted on a circuit board. The light source may be mounted on a flexible circuit carrying element. The heat dissipating material may be fixed to the flexible circuit carrying element. The heat dissipating material may comprise or consist essentially of aluminum. The heat dissipating material may be fixed to a circuit carrying element. The light source may be mounted on the circuit carrying element to which the heat dissipating material is fixed. The heat dissipating material may or may not be located around the circuit components. The heat dissipating material may only be located in the lamp around light sources. The light source may be an LED. The light source may be a solid state light source. The light source may be an inorganic LED.

Another embodiment is directed to a method for operating an interior LED lamp in a vehicle comprising receiving information representative of an amount of ambient light, and controlling the interior LED lamp based on the received information.

Controlling the interior LED lamp may comprise controlling a courtesy light function of the vehicle based on the received information, the courtesy light function incorporating the LED lamp. Controlling the interior LED lamp may comprise controlling the interior LED lamp based on the received information when a key to the vehicle is not in an ignition of the vehicle.

Another embodiment is directed to a method for operating an interior LED lamp in a vehicle comprising determining a criteria relating to an amount of heat using a circuit component that has a function in addition to providing information related to an amount of heat present, and controlling the LED lamp of the vehicle based on the determination.

The circuit component may consist essentially of a microprocessor/microcontroller. The microprocessor/microcontroller may be configured to control output intensity of the LED lamp based on the determination. Controlling the LED lamp based on the determination may comprise reducing the intensity of the LED lamp based on a high temperature reading. The circuit component may be located out of close proximity to an LED of the LED lamp that is controlled based on the determination. The circuit component may be located remote from all LEDs of the LED lamp that are controlled based on the determination. In some embodiments, the circuit component may be mounted on a circuit board while no LED controlled based on the determination is mounted on the circuit board. Determining a criteria relating to an amount of heat may comprise measuring timing of an occurrence of an event involving the circuit component and determining an amount of heat based on the timing of the occurrence. Controlling the LED lamp of the vehicle based on the determination may comprise controlling a drive current provided to an LED of the LED lamp.

One or more of the illustrative embodiments may be used in conjunction with each other according to some embodiments. Illustrative methods may be implemented in circuitry of an LED lamp (e.g. hardware and/or software) and illustrative devices and systems may be implemented as methods.

While the exemplary and illustrative embodiments illustrated in the FIGS. and described above are presently preferred, it should be understood that these embodiments are offered by way of example only. Accordingly, the present invention is not limited to a particular embodiment, but extends to various modifications that nevertheless fall within the scope of the claims or the invention as a whole.

While translating a dimming signal has been discussed above, any other signal used to change the intensity of a light source (light intensity varying signal) may also be translated. For example, a signal used to increase the intensity of a light source may be translated (e.g. when a courtesy function is used to turn lights on, when a user remotely changes an intensity of the light source, etc.). Each reference to a dimming signal discussed above is equally applicable to other light intensity varying signals.

What is claimed is:

1. A method for controlling an interior LED lamp in a vehicle, comprising:
receiving a light intensity varying signal from the vehicle; and
translating the light intensity varying signal for use in dimming an LED;
wherein the LED is configured to illuminate an interior of a vehicle.

2. The method of claim 1, wherein the light intensity varying signal is configured to vary the intensity of an incandescent light source.

3. The method of claim 1, wherein the light intensity varying signal comprises a dimming signal.

4. The method of claim 1, wherein translating comprises varying the intensity of the LED in different increments than the received signal.

5. The method of claim 1, wherein translating the light intensity varying signal comprises translating the light intensity varying signal using at least one of a microprocessor and a microcontroller.

6. The method of claim 5, wherein the at least one of a microprocessor and microcontroller, and the LED are in a common housing.

7. The method of claim 6, further comprising translating the light intensity varying signal with the at least one of a microprocessor and microcontroller for use in varying an intensity of a second LED, the second LED not located in a common housing as the at least one of a microprocessor and microcontroller.

8. The method of claim 1, wherein the translated light intensity signal comprises a pulse width modulated signal.

9. An interior lamp for a vehicle using the method of claim 1, comprising:
an LED light source configured to illuminate the interior of a vehicle; and
a processing circuit configured to receive a dimming signal and to translate the dimming signal for use in dimming the LED light source.

10. A method for contolling an interior LED lamp in a vehicle, comprising:
determining that the interior LED lamp should be dimmed;
sending a dimming signal; and
dimming the LED lamp in increments that appear substantially smooth to a person in the interior of the vehicle.

11. The method of claim 10, wherein dimming the LED comprises dimming the LED to less than about 10% of its maximum output.

12. A method for operating an interior LED lamp in a vehicle, comprising:
determining a characteristic of an LED of the interior LED lamp;
storing information relating to the characteristic in an electronic form; and
controlling the LED based on the stored information.

13. The method of claim 12, wherein the characteristic relates to an intensity of the LED.

14. The method of claim 12, wherein the characteristic relates to a color of the LED.

15. The method of claim 12, further comprising:
determining a characteristic of a second LED of the interior LED lamp;
storing information relating to the characteristic of the second LED in an electronic form; and
controlling the second LED based on the stored information.

16. The method of claim 15, further comprising controlling the LED based on the stored information relating to the characteristic of the second LED.

17. An interior lamp for a vehicle controlled according to the method of claim 12, comprising:
an LED light source configured to illuminate the interior of the vehicle; and
a processing circuit configured to receive information relating to a characteristic of an LED of the LED light source, and to control the LED light source based on the information.

18. The lamp of claim 17, wherein the processing circuit is configured to control the LED light source based on the information by adjusting the intensity of the light source.

19. The lamp of claim 17, wherein the characteristic is an intensity of an LED and the processing circuit is configured to control the characteristic such that a differenc in intensities is generally unperceptible to a human eye.

20. An interior lamp for a vehicle, comprising:
an LED configured to illuminate the interior of a vehicle;
a rigid circuit carrying element that carries components of a circuit of the interior lamp, the components coupled to the LED; and
a flexible circuit carrying element coupled to the rigid circuit carrying element, the LED being connected to the flexible circuit carrying element.

21. The interior lamp of claim 20, wherein the flexible circuit carrying element comprises a heat dissipating backing in the area of the LED.

22. The interior lamp of claim 21, wherein the heat dissipating backing is rigid.

23. An interior lamp for a vehicle, comprising:
a light source;
circuit components electrically coupled to the light source;
a heat dissipating material around the light source;
wherein a relative position between the circuit components and the light source is flexible.

24. The interior lamp of claim 23, wherein the circuit components comprise a switch and a resistor.

25. The interior lamp of claim 23, wherein the circuit components are mounted on a circuit board.

26. The interior lamp of claim 25, wherein the light source is mounted on a flexible circuit carrying element.

27. The interior lamp of claim 23, wherein the heat dissipating material is fixed to a circuit carrying element.

28. The interior lamp of claim 23, wherein the light source is an LED.

29. The interior lamp of claim 23, wherein the light source is a solid state light source.

30. A method for operating an interior LED lamp in a vehicle, comprising:
receiving information representative of an amount of ambient light; and
controlling the interior LED lamp based on the received information.

31. The method of claim 30, wherein controlling the interior LED lamp comprises controlling a courtesy light function of the vehicle based on the received information, the courtesy light function incorporating the LED lamp.

32. The method of claim 30, wherein controlling the interior LED lamp comprises controlling the interior LED lamp based on the received information when a key to the vehicle is not in an ignition of the vehicle.

33. A method for operating an interior LED lamp in a vehicle, comprising:
determining a criteria relating to an amount of heat using a circuit component that has a function in addition to, providing information related to an amount of heat present; and
controlling the LED lamp of the vehicle based on the determination.

34. The method of claim 33, wherein the circuit component consists essentially of at least one of a microprocessor and a microcontroller.

35. The method of claim 34, wherein the at least one of a microprocessor and a microcontroller is configured to control output intensity of the LED lamp based on the determination.

36. The method of claim 33, wherein the circuit component is located remote from an LED of the LED lamp that is controlled based on the determination.

37. The method of claim 33, wherein the circuit component is located remote from all LEDs of the LED lamp that are controlled based on the determination.

38. The method of claim 37, wherein the circuit component is mounted on a circuit board and no LED controlled based on the determination is mounted on the circuit board.

39. The method of claim 33, wherein determining a criteria relating to an amount of heat comprises measuring timing of an occurrence of an event involving the circuit component and determining an amount of heat based on the timing of the occurrence.
